(19) United States
(12) Patent Application Publication
(10) Pub. No.: US 2005/0114870 A1
(43) Pub. Date: May 26, 2005

(54) System and method for executing an application on a secured run-time environment

(76) Inventors: Dong Ho Song, Seoul (KR); Yean Jin In, Seoul (KR); Young Joon Chun, Koyang (KR); Sung Ryong Kim, Seoul (KR)

Correspondence Address: DLA PIPER RUDNICK GRAY CARY US, LLP, 2000 UNIVERSITY AVENUE, E. PALO ALTO, CA, 94303-2248, US

(21) Appl. No.: 10/718,867

(22) Filed: Nov. 21, 2003

(51) Int. Cl. G06F 13/00

(52) U.S. Cl. 719/328

(57) ABSTRACT

An application wrapper system and method provide a technique for privatizing application software resources from an operating system shared resources. The present invention allows the application software to execute in a secured run-time environment. The preferred embodiments of the present invention eliminates application conflict, protects operating system resources, provides multiple instance run-time for instance made to execute single instance and provides multi-user environment.

### FIELD OF THE INVENTION

The present invention relates to the field of computer software systems. More specifically the invention relates to the construction and implementation of a system for executing application software on an operating system within a secured run-time environment without affecting an application software resource on a client computer.

### BACKGROUND OF THE INVENTION

In an operating system, application software is executed using various operating system resources such as file system, registry system, shared libraries, COM, DCOM, IPC, environmental files, variables and others. These resources are shared globally for all application software installed for execution and the protections are limited during installation as well as at the time of application execution. With this prior-art, the application software has no private context to protect all the resources to overcome conflicts during installation and execution of application software. Hence keeping this in mind and in order to eliminate various application installation and run-time conflicts, an application wrapper is provided to create a secured run-time environment by privatizing several operating system resources under the application wrapper.

In the past, application software was designed to have all the necessary resources and was self-contained with a single executable file or a complex application may have several executables that may chain each other to execute the application. Executables that comes with the application does not interfere other application and could be used only by that application. Applications are distributed with all of the files used by that program without being concerned that other products might interfere with this application software.

Many applications in the past few years have bigger size of application files (element 132 in FIG. 2) and the size has grown dramatically. To reduce the size of the application files 132, the Windows operating environment provides libraries such as COM (common object method), DCOM, IPC to share the modules to Applications. With this environment, the application depends the capability of libraries. A module shared to the applications is said to be a dynamic link library and normally has the extension .DLL. The DLL acts as an application-programming interface (API) that makes Windows work. At the outset, sharing of library modules goes well without a problem. Most applications use only system library and rarely use private libraries. Microsoft windows applications use COM, DCOM, IPC and other libraries either by DLL host or SVCHOST.

Later, with the improvement of windows operating system 100, the library modules come with various versions. In most of the cases, an application probably experienced DLL problems and this may leads the application to behave strangely or no longer loads. This happens due to another program overrides to an older DLL, VBX or ActiveX file on their system or may be with an incompatible library version. The application could not run properly due to conflicts by environment settings, registry entries and incompatible library loaded already in the memory.

Further, Microsoft continued to provide updated versions of the DLL to have new functions and also to fix the bugs. Example. A commdlg.dll library used as a common dialog library. This library consists of common dialog boxes to obtain a filename or to select a color etc., for use with any windows application. At the start, application using common dialog requires the distribution of commdlg.dll file, since windows does not include. Later, it was included in the windows distribution to include the updated library files. Continuation of various versions of libraries causes the DLL hell problems. DLL-Hell is a real problem—one of the most serious problems facing application developers and system administrators today. Thus, it is desirable to provide a system and method for executing an application on a secured run-time environment and it is to this end that the present invention is directed.

### SUMMARY OF THE INVENTION

A technique for privatizing application software resources from an operating system shared resources is disclosed. The present invention allows the application software to execute in a secured run-time environment. The preferred embodiments of the present invention eliminates application conflict, protects operating system resources, provides multiple instance run-time for instance made to execute single instance and provides multi-user environment. The present system provides an application wrapper, which includes privatized virtual file system created from an operating system file system, privatized virtual registry created from an operating system registry system, privatized operating system shared component resources, privatized application configuration resource and privatized environmental resources for application variables.

The system includes an application wrapper to shield the application software resources. Shielding application software resources creates a secured run-time environment for executing application software and the application software resources are protected. The system provides a run-time environment to application software that is visible to be an operating system run-time environment without installing the application software resources. While the application software is executed the resources are simulated in the secured run-time environment. The system monitors the application run-time request to determine the required portion of application software resources for execution and serves the application software resources to incrementally execute the application software. The system protects the behavior of the application software from other application and operating system and eliminates application conflicts from other running application software. The system executes multiple instances of a single software application. The system keeps the application software resources away from operating system resources, whereby operating system resources are protected from application software resources. The system allows full access to application software that requires to access for variation occurs to application software resources within the application wrapper.

### BRIEF DESCRIPTION OF THE DRAWINGS

There are presently shown in the drawings embodiments which are presently preferred, it being understood, however, that the invention is not so limited to the precise arrangements and instrumentalities shown, wherein the figures, explains how the application software run-time resources are secured and brought down privately.

FIG. 1 is a block diagram, which illustrates the concepts of system introduced on an operating system;

FIG. 2 is a block diagram, which illustrates, the parts of a preferred embodiment of the application wrapper system of the present invention.

FIG. 3 is a block diagram, which illustrates the abstraction of virtual file system for creating a privatized virtual file system to provide separate file access to application software which is preferred embodiment of the present invention.

FIG. 4 is a block diagram, which illustrates the abstraction of virtual registry system for creating a privatized virtual registry system to provide separate registry access to application software which is a preferred embodiment of the present invention.

FIG. 5 is a flow chart that represents the functions of initializing several modules and launching secured application software in accordance with the invention.

FIG. 6 is a flow chart shows the functions of process manager for maintaining each process status of secured application in accordance with the invention.

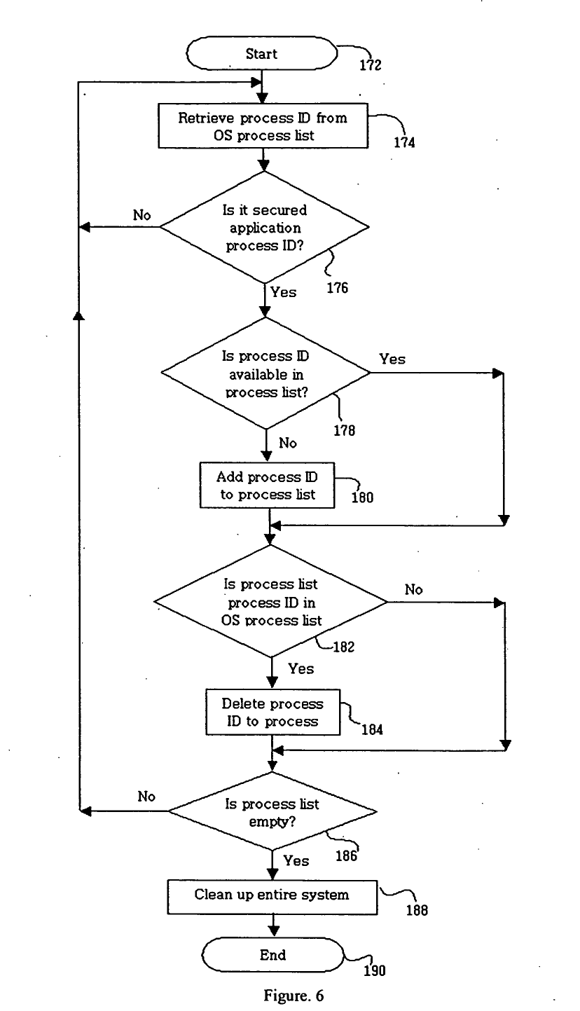

FIG. 7 is a flow chart represents the functions of privatized virtual file system, for the purpose of private file system resource to secured application software in accordance with the invention.

FIG. 8 is a flow chart represents the functions of privatized virtual registry system, for the purpose of private registry system resource to secured application software in accordance with the invention.

FIG. 9 is a flow chart represents the functions of file path amendment method in the said privatized virtual component system, for the purpose of private component system resource to secured application software in accordance with the invention.

FIG. 10 is a flow chart shows the injection of hooking DLL for intercepting DLL calls in accordance with the invention.

FIG. 11 is a flow chart represents the functions of private environment variable system, for the purpose of private environment variable resource to secured application software in accordance with the invention.

FIG. 12 is a flow chart shows the process of cache manager for servicing file I/O request in accordance with the invention.

FIG. 13 is a flow chart shows the process of cache manager for servicing registry I/O request in accordance with the invention.

FIG. 14 is a flow chart represents the functions of registry redirection method in the said privatized virtual component system, for the purpose of privatizing component loading to secured run-time application software in accordance with the invention.

FIG. 15 is a flow chart represents the RPC (Remote Procedure Call) message amendment method for IPC (Inter Process Communication) to redirect location of the requested component to a privatized virtual component, for the purpose of privatizing component loading to secured run-time application software in accordance with the invention.

### DETAILED DESCRIPTION OF A PREFERRED EMBODIMENT

The invention is particularly applicable to a Windows-based operating system that is being executed by a personal computer system and it is in this context that the invention will be described. It will be appreciated, however, that the application wrapper system and method in accordance with the invention has greater utility since the application wrapper system may be used with other operating systems, such as the Macintosh OS, Linux, Unix and it may be used with other computer systems, such as servers, personal digital assistants, laptop computers, distributed computer systems, peer-to-peer systems and the like.

In a preferred embodiment described below, the application wrapper system is implemented on a typical personal computer system running a Windows-based operating system wherein the computer system has well known components including one or more CPUs, input/output devices, such as a display, printer, mouse. keyboard, etc., memory (DRAMs or SRAMs), a persistent storage device, such as a hard disk drive, tape drive. optical drive, etc. and other peripherals. As stated above, the application wrapper system may be implemented on a variety of other computer systems and with a variety of other operating systems. In the preferred embodiment, the application wrapper system is implemented as one or more software modules that are executed by the CPU of the computer system and inter-operate with the operating system on the computer system. The application wrapper system may also be implemented as one or more pieces of software stored on a hardware device that are executed by a CPU of a computer system. Now, the application wrapper system and method in accordance with the invention will be described in the context of a personal computer system executing a Windows-based operating system.

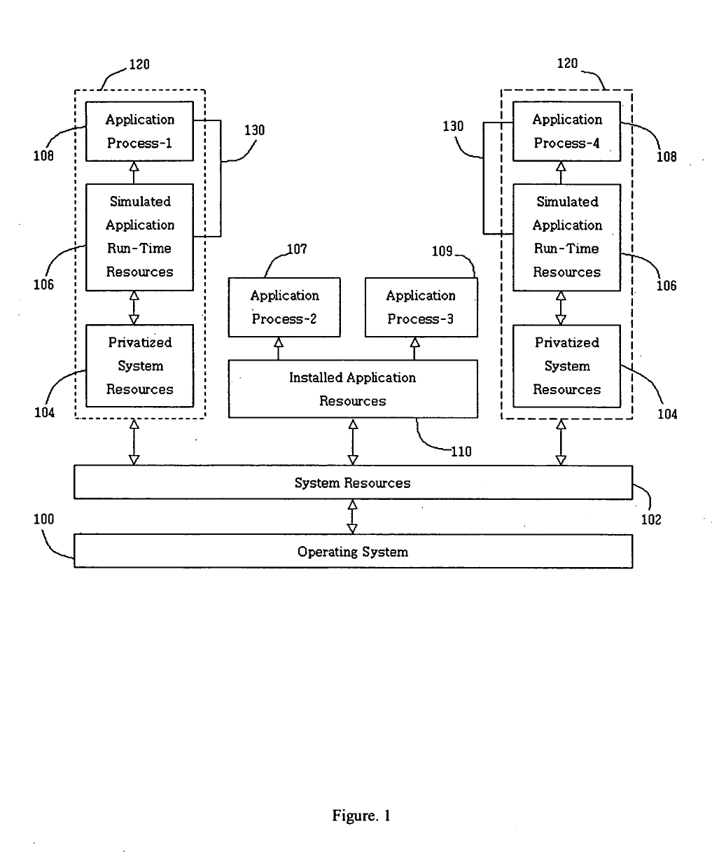

FIG. 1 shows a preferred example of an application wrapper 120 in accordance with a presently preferred exemplary embodiment of this invention. In the present invention, the application wrapper 120 includes various privatized resources and modules to create a secured run-time environment 130 by privatizing the existing operating system 100 resources. Referring to FIG. 1, two application wrappers 120 are shown that are built on top of typical computer system resources 102 and a typical operating system 100. Each secured run-time application 108 (Application Process-1 and Application Process-4 in the example shown in FIG. 1) may be executed in a secure environment as shown. FIG. 1 also illustrates a first software application (Application Process-2) 107 and a second software application (Application Process-3) 109 that are being executed in a typical fashion with installed application resources 110 that operate on top of the operating system 100. Each application wrapper system 120 provides a secured run-time environment 130 that includes various privatized resources, such as a simulated application run-time resource 106 and privatized system resources 104.

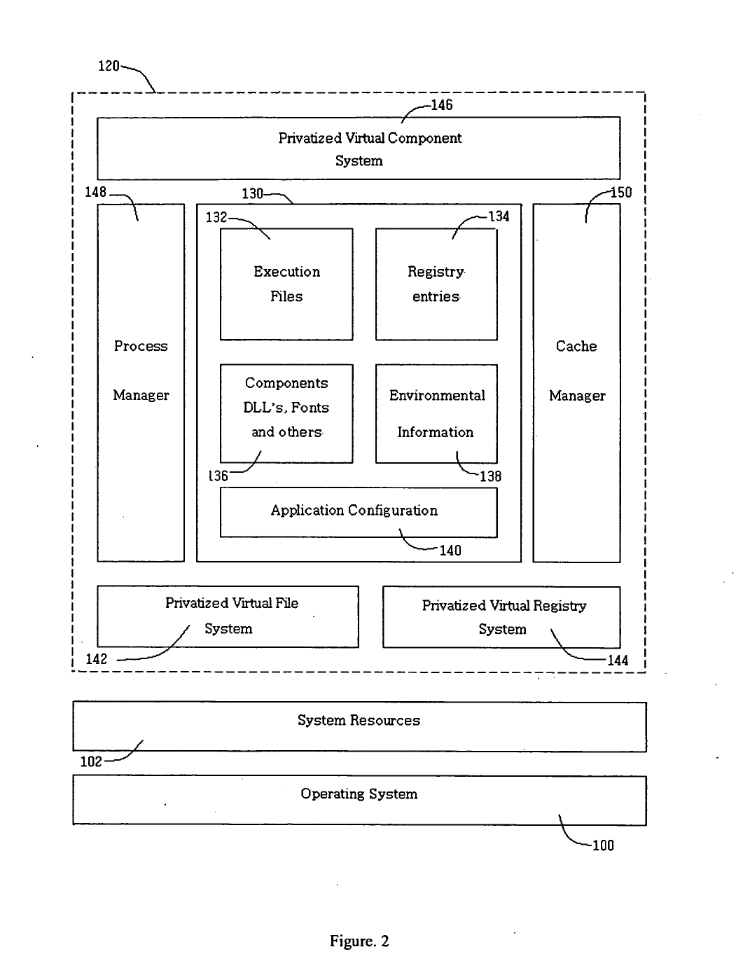

FIG. 2 shows a preferred parts of an application wrapper 120, the parts includes privatized virtual file system 142, a privatized virtual registry system 144, a privatized virtual component system 146, process manager 148, cache manager 150. Further, the secured run-time environment 130 created by the privatizing technique includes files 132, registry entries 134, DLL's, COM, DCOM, IPC, fonts and other shared modules 136, privatized environmental variables 138 and privatized application configuration 140. Each of the privatized resources and the parts are discussed and explained through several drawings along with technical descriptions.

The application wrapper system shields the application software resources. The shielding of the application software resources creates a secured run-time environment for executing application software and the application software resources, which is protected. The system provides a run-time environment to application software that is visible to be an operating system run-time environment without installing the application software resources. While the application software is executed the resources are simulated in the secured run-time environment. The system monitors the application run-time request to determine the required portion of application software resources for execution and serves the application software resources to incrementally execute the application software. The system protects the behavior of the application software from other application and operating system and eliminates application conflicts from other running application software. The system executes multiple instances of a single software application. The system keeps the application software resources away from operating system resources, whereby operating system resources are protected from application software resources. The system allows full access to application software that requires to access for variation occurs to application software resources within the application wrapper.

Privatized Virtual File System

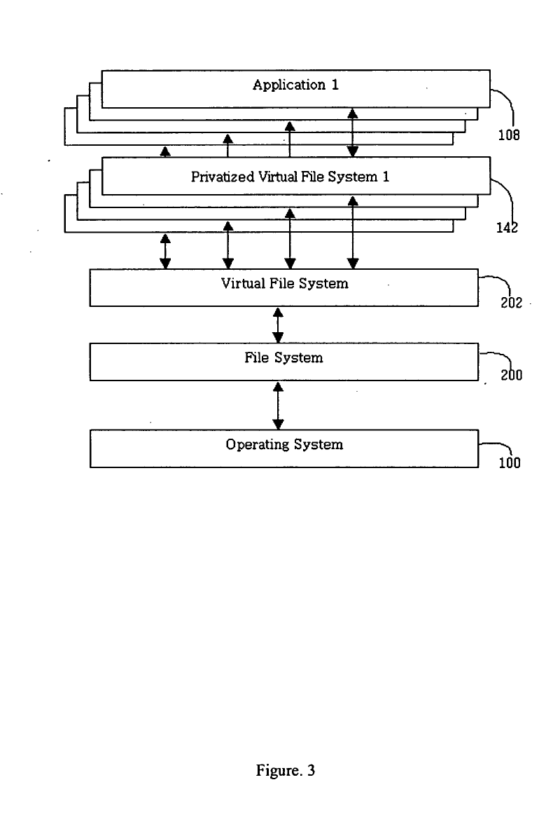

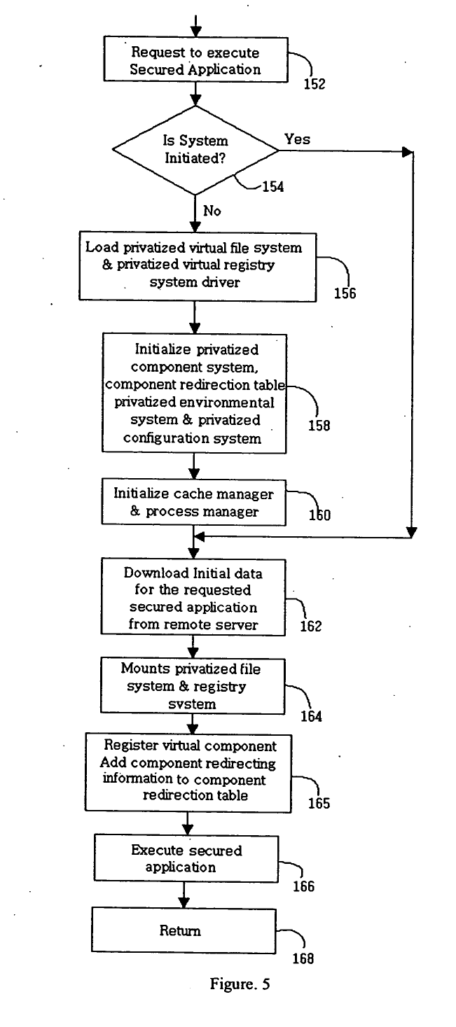

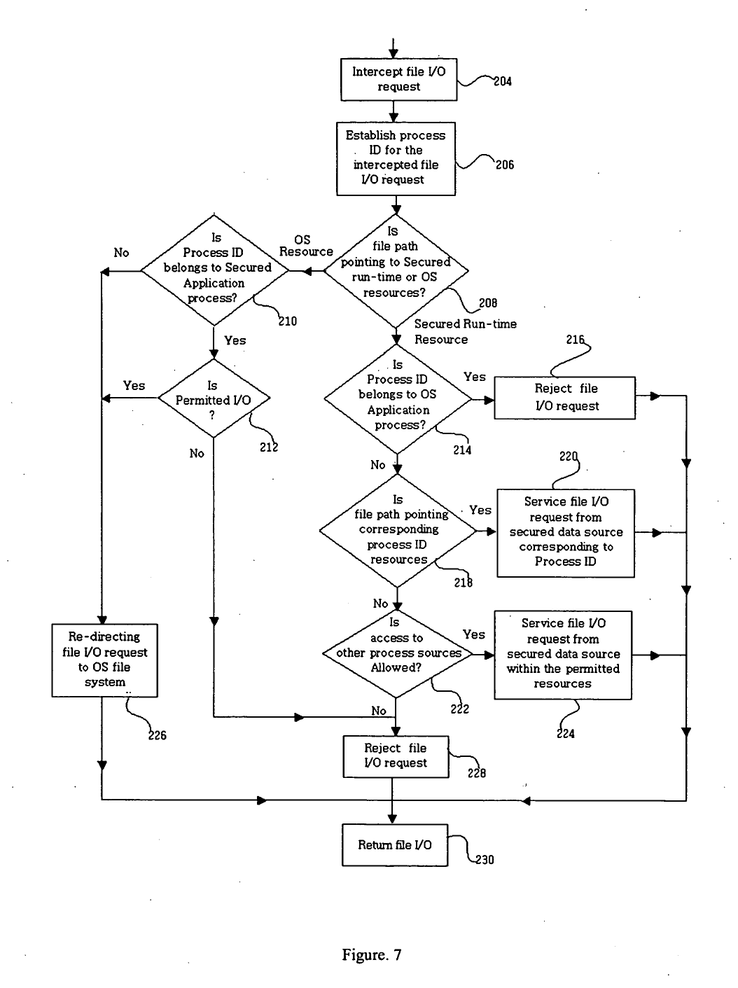

Normally, a storage media is well organized with various file system by an operating system 100 to access the files, directory and data efficiently. In the present invention, the existing file system on an operating system 100 is controlled in such a manner to provide a privatized virtual file system 142 under an application wrapper 120. FIG. 7 describes how a privatized virtual file system 142 is created under the application wrapper 120. In FIG. 3, a virtual file system 202 abstractions for creating the privatized virtual file system 142 is shown. Using the privatized virtual file system 142 and the virtual file system 202, the secured application software 108 has separate file access to secured application software in accordance with a preferred embodiment of the invention. The privatized virtual file system device driver module shown in FIG. 7 creates the privatized virtual file system 142 for secured application software 108 by mounting the file system information (see step 164 in FIG. 5) corresponding to the selected application software. The pre-required encrypted secured application data is stored in a pre-determined directory on a storage disk, which is available in a form of a commonly structured cache database is used for initialization of secured application software. Each secured application data in the cache database has a unique application pack identification (id) to identify the relevant application data. In general, each software application has an id that is used to identify the software application.

The privatized virtual file system 142 is mounted using the privatized virtual file system mounting information, which is retrieved and decrypted from the said cache database for the particular requested secured application software to execute on a secured run-time environment 130 as shown in FIG. 1. A process manager 148 (See FIG. 2) within the application wrapper 120, which initiates the selected application software, can view the directory and file information. The said process manager initiates the main executable file to execute the secured application software (in step 166 shown in FIG. 5). During this initiation process, relevant calls are triggered to retrieve the data required for continuing the execution.

When a user process issues a file input/output (I/O) function call, the subsystem invokes the corresponding service call to request the operation on behalf of the caller. Here, the privatized virtual file system driver receives file I/O requests (in step 204 in FIG. 7) from normal application software and secured application software to open, create, read, write, close and other file operation functions. These file I/O requests typically originate in the user process. Whenever any file I/O request is received from a user process by the said privatized virtual file system driver for a file residing on a mounted storage volume, then the said privatized virtual file system driver redirects the request to the operating system 100 file system driver to manage the mounted logical volume. Before forwarding the request to operating system file system driver, however, the said privatized virtual file system driver checks to see if there is any file I/O request representing privatized virtual file system 142. Therefore, the privatized virtual file system driver module intercepts the I/O request before it reaches the operating system file system to provide a secured application data from a secured application pack.

The privatized virtual file system device driver can determine the file I/O request received from the user process for a particular application process using the known process id. This file I/O request is classified into two categories. One is the file I/O request received from the normal application and the other is from the secured application software created under the application wrapper 120. The privatized virtual file system driver will dispatch the entire file I/O request received from normal application software process directly to the operating system file system driver to service the file I/O request to normal application software. The operating file system driver performs appropriate processing and returns the results to the privatized virtual file system driver and the privatized virtual file system 202 (in FIG. 3) eventually returns the results to the requesting process. Hence the state of file system access is unchanged for normal application software 107 (See FIG. 1). The file I/O request received from secured application software is filtered and serviced based on various conditions. Conditions are made to protect the application software data and to service the various file operations.

Based on the process ID, the corresponding application data is serviced to the requested application software. Further, based on the file I/O request from the secured application software with the corresponding process id is serviced on various pre-determined conditions to open, create, read, write, close and other file operation functions. At step 204 in FIG. 7, the file I/O request is intercepted. Once the file I/O is intercepted, at step 206 in FIG. 7, the privatized virtual file system 142 establishes the process ID for the intercepted file I/O request. At step 208 in FIG. 7, the file path available in the file I/O request is verified to know whether it points to operating system 100 resource or secured application resource. In one condition the privatized virtual file system 142 services the I/O call, which points to operating system 100 resources. As show in FIG. 7 at step 210, if the process ID does not belong to secured application process then the I/O call is re-directed to (step 226 in FIG. 7) operating system 100 file system otherwise the control goes to step 212 of FIG. 7. Similarly, if the process ID belongs to a secured application process and if the I/O call is permitted (step 212 in FIG. 7) to access then the I/O call is re-directed to operating system 100 file system. Finally, if the process ID belongs to secured application process and if the I/O call is not permitted to access then the I/O call is rejected (step 228 in FIG. 7) and returned to requested process.

Next, the privatized virtual file system 142 services the I/O call, which points to the secured runtime resources. At step 214, 218, 222 in FIG. 7, it verifies, If the process ID belongs to an operating system 100 application process or if the file path does not point to a corresponding process ID resource or if the access is not permitted to use other process resources then the file I/O request is rejected and returned to the requesting process. At step 220 in FIG. 7, the I/O calls are serviced from secured data source corresponding to process ID and returned to requesting process only if the file path points to corresponding process ID resources (step 218 in FIG. 7). The I/O calls also are serviced from secured data source within the permitted resources shown in FIG. 7 at step 222 and returned to requesting process for file path pointing other secured application resources based on access permission. This will be useful for inter process application execution.

Privatized Virtual Registry System

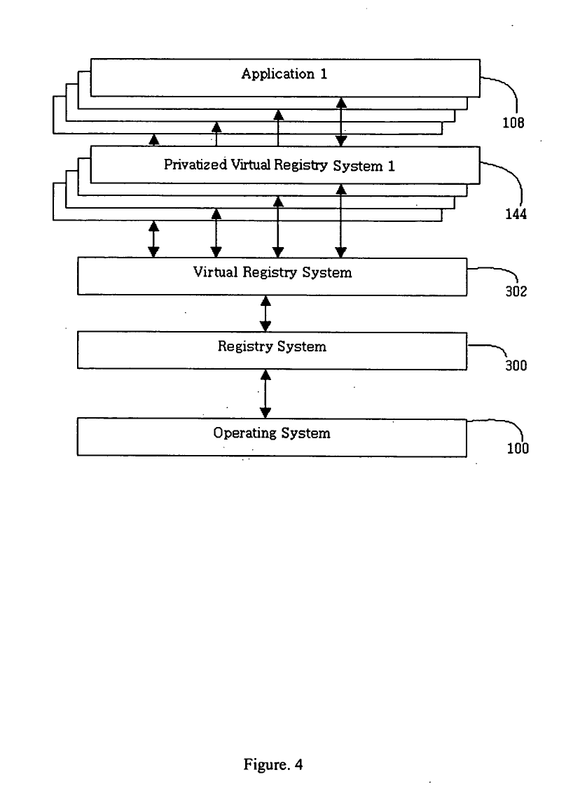

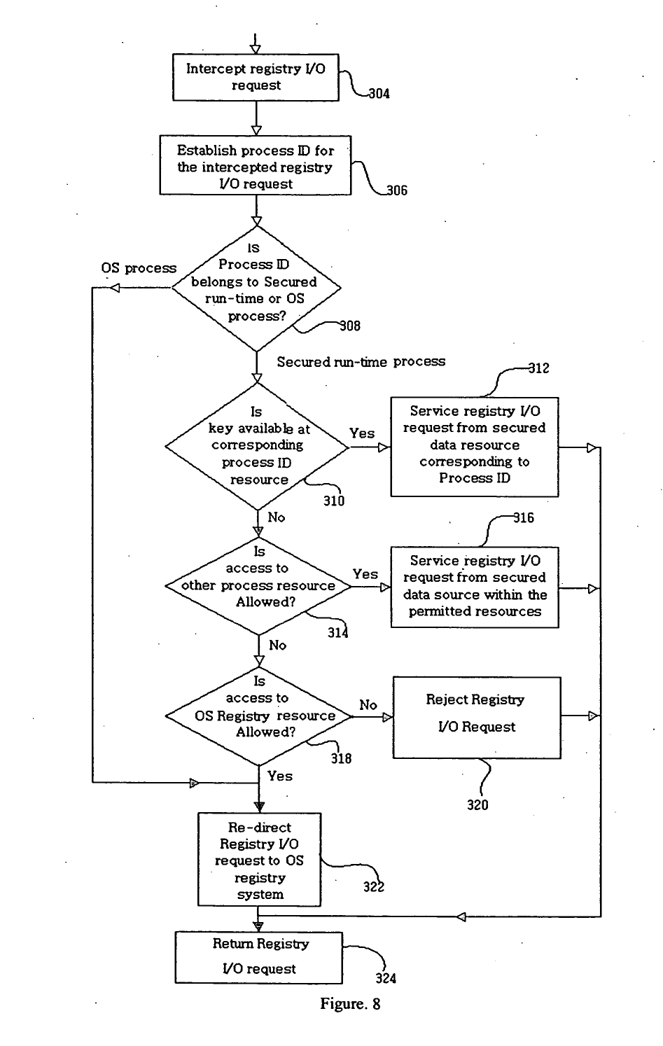

An operating system 100 includes a well-known registry system 300 shown in FIG. 4. The Registry is a database used to store settings and options for the operating system 100 environments. It contains information and settings for all the hardware, software, users, and preferences of the computer system. Whenever a user makes changes to a particular setting, system policies, installed application software, the changes are reflected and stored in the registry. This information is required for processing application software. In the present invention, the existing registry system on an operating system 100 is controlled in such a manner to provide a privatized virtual registry system 144 under an application wrapper 120. FIG. 8 describes how a privatized virtual registry system 144 is created under the application wrapper 120.

In FIG. 4, a virtual registry system 302 abstraction for creating a privatized virtual registry system 144 is shown to provide a separate registry access to secured application software, a preferred embodiment of the present invention. The virtual registry system 302 and privatized virtual registry system 144 is built on top of the operating system 100 and the registry system 300 of the operating system as shown in FIG. 4. The secured software application 108 then accesses the privatized virtual registry system 144 as shown. A privatized virtual registry system device driver is the heart of a privatized virtual registry system. It is dynamically loaded and initiated before the secured application software initiation. All registry activity received from any application software is directed through this routine, so the privatized virtual registry system driver catches all registry activity carried out on a computer system.

A privatized virtual registry system driver creates a privatized virtual registry system 144 for the secured application software 108, which has a hierarchal structure similar to the physical registry structure of the registry system 300. The physical registry consists of main branch keys known as a Hive and a Hive contains Keys. Each key can contain other keys referred to as sub-keys as well as values. The values contain the actual information stored in the real registry database. Similarly, the values for the privatized virtual registry system 144 is retrieved and decrypted from the said cache database.

When the application software is initiated or executed, it may require various registry values to process the application software. Normally, registry keys are accessed through various queries to its subsystem for all accesses to the registry database 300. When a user process issues a registry query, the subsystem invokes the corresponding service call to request the operation on behalf of the caller. Here, the privatized virtual registry system 302 driver receives the registry query requests from normal application software and secured application software to open, create, read, write, delete, close and other registry calls to access the registry database 300. Any registry query that is received from a user process by the privatized virtual registry system 302 driver for a registry key or value residing on a real registry database, the privatized virtual registry system 302 driver redirects the request to the operating system 100 registry system driver to manage the real registry database. Before forwarding the request to operating system registry system driver, however the privatized virtual registry system 302 driver checks to see if any registry queries representing privatized virtual registry system. Therefore, the privatized virtual registry system driver module intercepts the registry query before it reaches the operating system registry system to provide a secured registry value from a secured registry pack provided by the cache database.

In FIG. 8 at step 304, the said privatized virtual registry system driver intercepts for an open, create, read, write, delete, close or other registry query calls. The origination of the intercepted registry call received from the user process for a particular application software process can be established by identifying the process id. At step 306 in FIG. 8, the source or the requested process for the intercepted registry call is established. This registry query is classified into two categories as shown in FIG. 8 at step 308. That is classified either as a query from the normal application or a query from the secured application software created under the application wrapper 120. As shown in FIG. 8 at step 322, privatized virtual registry system driver will dispatch the registry query received from normal application software process directly to the operating system registry system driver to service the registry query to normal application software. The operating system registry system driver performs appropriate processing and returns the results to privatized virtual registry system driver and the privatized virtual registry system 302 eventually returns the results to the requesting process. Hence the state of OS registry system access is unchanged for normal application software. Registry query received from secured application software is filtered and serviced based on various conditions shown in FIG. 8 at steps 310, 314 and 318. Conditions are made to protect the registry values and to service the various registry operations. At step 310, the registry call established as secured application is further verified that if the requested registry call belongs to the same process then the registry call is serviced (Step 312) with the secured registry data source corresponding to the process ID otherwise further the call is verified (Step 314) that if access to other process resource is permitted for this requested call then the registry call is serviced (Step 316) within the permitted resource. Finally, for the process ID established as secured application software and if the registry call does not belong to same process or within the permitted resource then that requested registry call is rejected (Step 320) and returned to the requesting process. Thus, the registry access for the secured application is serviced privately within their private data resource.

Privatized Virtual Component System

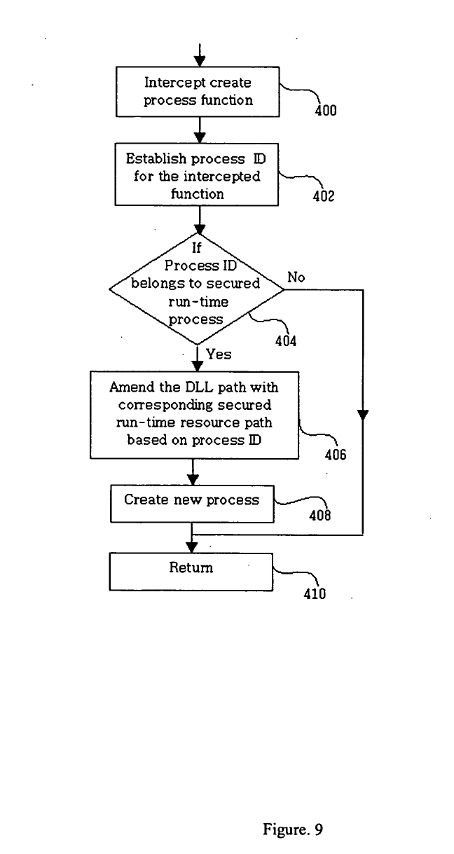

FIG. 9, 10, 14, 15 illustrates more details and steps performed by the privatized virtual component system 146 (shown in FIG. 2) for loading shared component to a private environment. In the present invention, application wrapper 120 includes a component loader, which a module for loading any version of components required for a particular application. For Example: Windows components COM, DCOM, Active X, VBX, OLE and other application specific components, shared across the operating system 100 to execute several common process. These components are delivered with various features. The components are not stable for all the process. In the preferred embodiment of the present inventions, the privatized virtual component system loads the required version of components for the specific secured application software.

Basically, whenever an application process requests a component then the said component can be searched from the same application process space or from different process space such as Inter Process Communication called IPC, which requires component loading from different process space. The said component calls are processed in different methods in windows operating system. The method includes loading component directly from the file path specified or from the default system directory, loading component based on registry information such as GUID specified, which addresses the component file path through the windows registry, loading component from other process space through service control manager or SCM with in-process or out-process technique, which is based on registry information.

In the present invention, the above said component loading methods are privatized. The said privatized virtual component system is initialized (Step 158 in FIG. 5) during the initialization of the said application wrapper system. The initialization includes component hooking mechanism for intercepting component calls and a component redirection table for identifying the redirecting information.

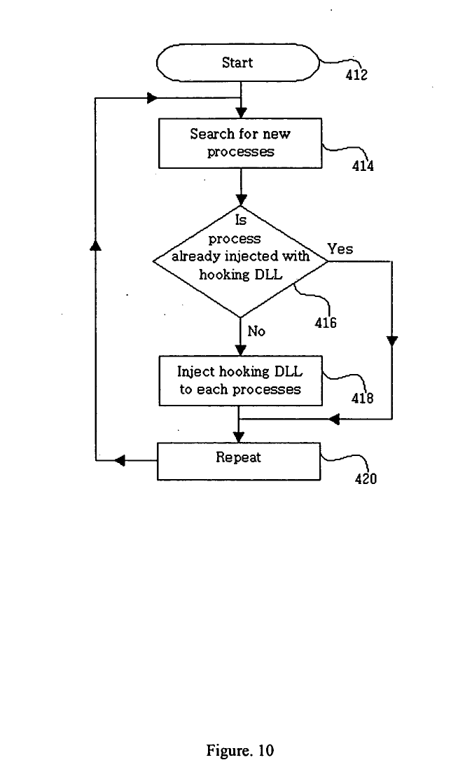

As shown in FIG. 10, the component intercepting module and method monitors each new process or processes (Step 414), which is not injected with a hooker component. In step 416, the method determines is the process already has a hooking component. If the process already has a hooking component, the method goes to step 420 and loops back to step 414. If the process does not already contain a hooking component, then the component hooker module is injected (Step 418) to all the process available in the operating system process list. The said component hooker module is common and known to one skilled in the art. Furthermore, whenever a new process is initiated, the component hooker is injected into the initiated process. Once the component hooker is injected to each process, the injection will bypass all the component function call to hooker component available in the memory for each process. The component hooker is made in such a way to intercept the required component call and to call appropriate modules based on the intercepted component call. The said intercepting module is used for intercepting component calls and the same is referred in the privatizing component loading methods.

In FIG. 5 at step 154 and 165, whenever a secured application is selected for execution, the said application launcher registers privatized virtual components required for the secured application to use in service control manager for IPC and adds component redirecting information for each component required by each secured application to the component redirection table, which is created during the said application wrapper initialization. The said component redirection table contains redirecting information such as component location, real GUID addressing a component available on a real file system and a corresponding privatized GUID addressing a component on privatized virtual file system. This table serves component redirecting information to search and identify the location of the privatized virtual component. Using the information from the said redirection component table, the GUID belongs to a shared component on a real file system can be translated to locate the component available on a said privatized virtual file system and privatized virtual component created during the initialization of secured application can be identified for translating RPC messages to redirect the process to load the said privatized virtual component created. Once the said secured application is terminated and if the component redirection information is not relevant for any other secured application process then the said component redirection information is deleted from the said component redirection table. The said component redirection table is referred in the privatizing component loading methods.

Privatized Virtual Component Using File Path Amendment

In one embodiment of the present invention for privatizing the component loading discloses the method of replacing the file search path to locate the component from the secured application pack corresponding to the said secured application process. In the present invention, the method of file search path amendment works through two modules. One module works for intercepting component calls as discussed above by injecting hooker component to all process shown in FIG. 10 and other one shown in FIG. 9 works as a privatized virtual component system to replace the file path with full redirected path name, which points to privatized virtual file system 142 location corresponding to the said secured application.

In FIG. 9, the present invention shows one embodiment of providing the said privatized virtual component system. Whenever an application process requests a function call such as create process, then the function call is intercepted by the said hooker component and the said hooker component calls the component file path amendment module to privatize the component loading. At step 400, the component call is intercepted. The intercepted component call such as create process function for component loading will not have any path name except the required component name. In step 402, the system will establish the relevant process ID for the intercepted component call to classify the requesting process as normal application or as secured application. In step 404, based on the process ID, the method determines if the process ID belongs to normal application or secured run-time process. If the process ID belongs to secured application then as shown in step 406, based on process ID, the said component (DLL) path is amended with the corresponding component file path addressing the location of the said secured application. As shown in step 408, after amending the path name, the private component system will create a new process with the amended path name for the requested secured application to resume the loading of component from the secured application pack. Thus, based on the amended component path, subsequent calls for loading the component will use the said privatized virtual file system to load the component from the private data resource. Hence, amending the component path with the relevant secured application path privatizes the component loading.

Privatized Virtual Component Using Registry Redirection

Another embodiment of the present invention for privatizing the component loading discloses the method of replacing the GUID of registry system to locate the component address to private data resource through the said privatized virtual registry system and privatized virtual file system.

Normally, COM component has a global unique ID said as GUID in the windows operating system registry. The said GUID used as a reference to locate the component stored on a file system. Whenever a function such as CoCreateInstance, CoGetClassObject available in a component, if called by an application process then that call will search the windows operating system registry with an unique GUID for getting component path information to locate the component on a windows file system. Thus for the specified function call, the corresponding component location is addressed through the windows operating system registry using the GUID, which is available at function call.

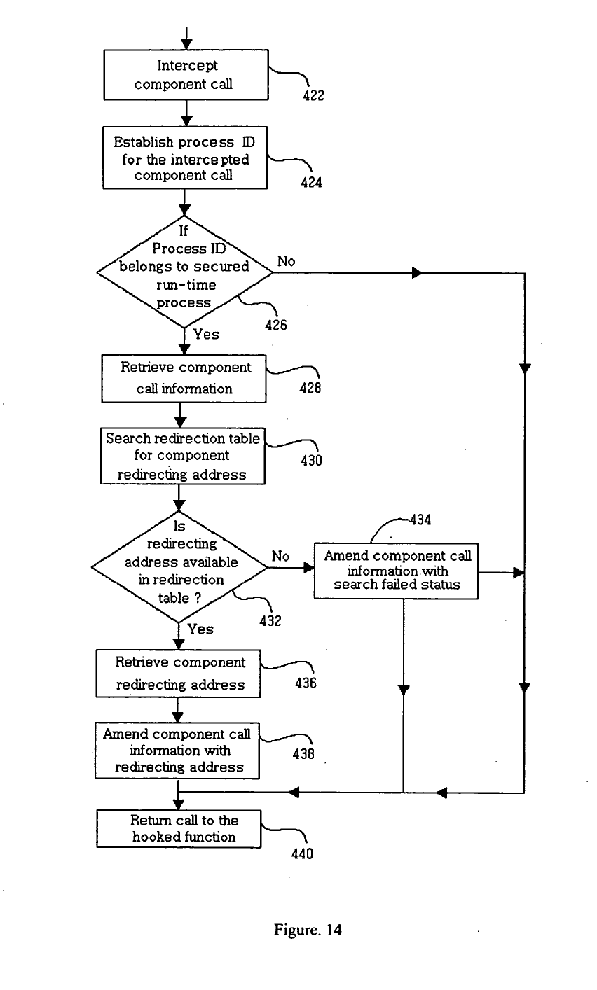

In the present invention, another embodiment of privatizing the component loading comprises component hooking and redirecting the search to the privatized virtual registry system. FIG. 14 shows another embodiment of privatizing the said component call. The steps shown in the figure are described below. In step 422, the component call originated from application process is intercepted using the said component hooking mechanism. The intercepted component call is verified to know whether it belongs to the said secured run-time application. In step 424, the process ID is identified. By knowing the application process ID relevant to the component call, can identify which application process requesting the component. In step 426, the identified process ID is compared to establish processes originated from secured application and normal application. Based on the comparison result, if the process ID established as normal application then without any changes, the said component call is redirected to next process by returning the original values. Whereas, if the process ID established as secured application then the values for the said component call is privatized through the steps between step 422 and step 438.

Once the said component call is established as secured application, the information such as component address, GUID and messages from the component call were retrieved as shown in FIG. 14 at 428. In order to privatize the component, the call information addressing the real operating system resource should be amended with information addressing the secured application pack corresponding to each secured application process. The information for amending the said component call information is available in the said component redirection table, which can be searched with the component address available from the retrieved call information. Component address will have a corresponding redirecting component address in the said component redirection table for the calls originated from the said secured application. In FIG. 14 at step 430, based on the said component address, the corresponding said redirecting component address is searched in the said component redirection table. At step 432, based on the search result, if the search is successful then the process is branched to step 436 for privatizing the component or else the process is branched to step 440 for returning the hooked component call by amending the component call information with failed status in step 434. In step 436 of FIG. 14, redirecting component address is retrieved from the said component redirection table. In step 438 of FIG. 14, component address originally available in the component call is replaced with the redirecting component address. In step 440 of FIG. 14, the hooked component call is returned with appropriate amended information. Thus the component loader will call subsequent call with the said appropriate amended information, which passes through privatized virtual registry system and privatized virtual file system for locating and loading the component from the corresponding said secured application pack.

Privatized Virtual Component Using RPC Message Amendment

Another embodiment of the present invention for privatizing the component loading discloses the method of RPC (Remote Procedure Call) message amendment for IPC (Inter Process Communication) to redirect the location of the requested component to a privatized virtual component. The said RPC message amendment will redirect the component search to privatized virtual component by searching the said service control manager or SCM for the said privatized virtual component, which is created during the initialization of secured application.

Generally, component calls related to Inter Process Communication is requested by remote procedure call or RPC is passed through service control manager or SCM in windows operating system. The said component call requesting a component registered in service control manager is searched and addressed through service control manager to locate the component location. Further, the search is made through in-process or out-process technique. Whenever the component call passed through the said service control manager, if failed to locate the component through in-process within the local host then the call is redirected to search the component through out-process from the remote host. Both in-process or out-process searches the registry system to locate the physical address of the requested component.

In the present invention, the calls to service control manager is replaced with privatized virtual component information available in the component redirection table and redirected the process to the said service control manager to use the privatized virtual registry system, which in further redirects to use privatized virtual file system to locate the physical address of the component location within the corresponding secured application pack. Here, both in-process or out-process always serviced through the privatized virtual registry system.

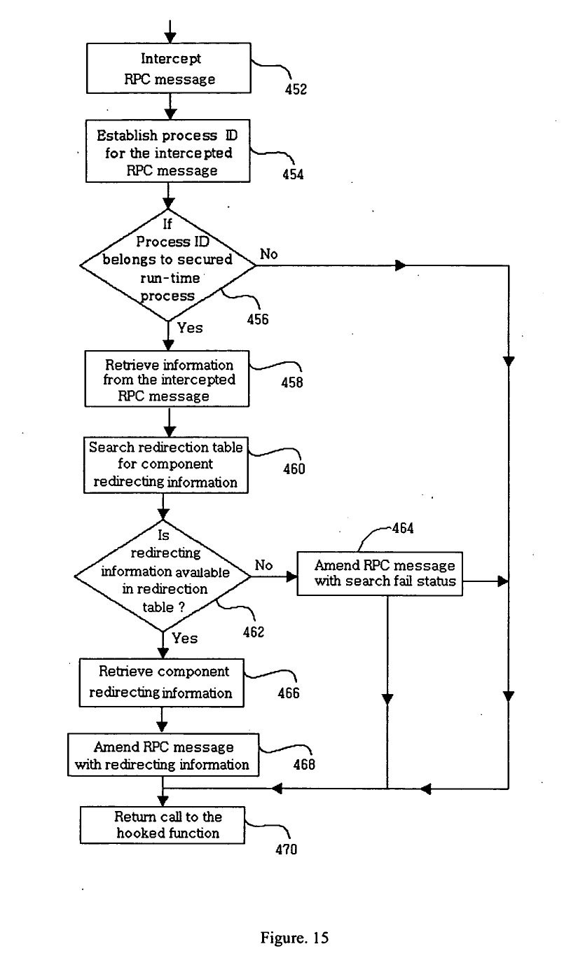

In FIG. 15 at step 452, the RPC message is intercepted to privatize the component loading. In step 454, the process ID corresponding to the intercepted message is identified. At step 456 in FIG. 15, the identified process ID is compared to establish processes originated from secured application and normal application. Based on the comparison result, if the process ID established as normal application then without any changes, the said component call is redirected to next process by returning the original values through the step 470. Whereas, if the process ID established as secured application then the values for the said component call is privatized through the steps between step 458 and step 468 in FIG. 15.

At step 458 in FIG. 15, the information such as component and messages from the said RPC call were retrieved. In order to privatize the component, the call information addressing the real operating system resource should be amended with privatized virtual component information corresponding to each secured application process. The information for amending the said component call information is available in the said component redirection table, which can be searched with the said component information. Each component will have corresponding redirecting component information in the said component redirection table for the calls originated from the said secured application. In step 460 of FIG. 15, based on the said component information, the corresponding said redirecting component information is searched in the said component redirection table. At step 462, based on the search result, if the search is successful then the process is branched to step 466 or else the process is branched to step 470 by amending the RPC message with failed status in step 434. In step 466 of FIG. 15, redirecting component information is retrieved from the said component redirection table. In step 468 of FIG. 15, component address originally available in the component call is replaced with the redirecting component information. In step 470 of FIG. 15, the hooked component call is returned with the replaced RPC messages. Thus the said RPC will continue to call subsequent call with the replaced messages, which further searches the SCM for the privatized virtual component created during the initialization of secured application, which further passes through privatized virtual registry system and privatized virtual file system for locating and loading the component from the corresponding said secured application pack.

Thus, in the present invention, one preferred embodiment, the application wrapper 120 provides a privatized virtual component system for each secured run-time application. The uses of shared component within the application are provided to keep the application run under independent use of component files. It protects the operating system 100 component files and provides version independent component files to the application. It keeps the operating system component files to original state. Applications use their own version of component files.

Applications use font resources from an operating system 100, which is shared globally to several processes. Any application requires installing a font for its own purpose should be added in the font resources available in the operating system 100. These fonts are also shared globally and affect the operating system 100.

In the preferred embodiment, Application wrapper 120 provides an application specific font resource and resolves conflicts between fonts. Any application requires a particular font to be installed for it's own purpose should be installed in the operating system 100. Installing fonts for each application or related version of application may require using a same kind of fonts or updated fonts. Use of same font ID number will lead to font conflicts. Application wrapper 120 avoids font conflicts from fonts installed by other application and keeps protected from system fonts and other application. Installing and use of new fonts within the application are provided.

Environment Variables

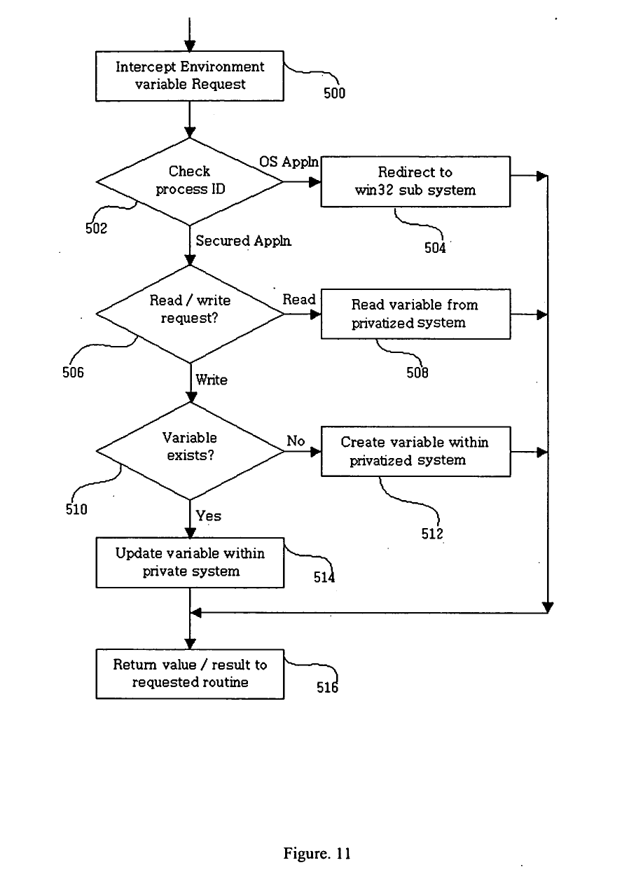

In the present invention, application wrapper 120 provides virtual environment variables 138 to application software created within the Application wrapper 120. An application requires environmental information are set in environment variables. FIG. 11, refers to environmental information 138 for setting private environmental information to an application software. Environment variables can be defined in two ways. That is system environment variables and user environment variables. An environment variable includes information such as a drive, path, or filename. Provides information to operating system 100 and application to perform tasks based on environmental settings. For example, an environment variable specifies the temporary storage directory to keep the temporary files used by the application. Application wrapper 120 sets the required environment variables virtually for the application software.

In the present invention, the private environment system intercepts (in step 500) calls for environmental variable request and determines the requesting process ID corresponding to the intercepted call. In step 502, the process ID for the particular request is determined. Once the process ID is determined, the type of requesting application is found and established as an operating system 100 process or a secured application process. Further, it is confirmed to know whether the requesting process is currently active under secure run-time environment by searching the process ID in process list. If the process is not originated from secured run-time environment 130 then the call is redirected (in step 504) to win 32 sub-systems and the operation for the particular request will be serviced by operating system and a return value/result is returned to the requested routine in step 516.

An environment variable call originating from secured applications is further classified into read/write operation in step 506. For any read operation, the private subsystem will search and retrieve (in step 508) the requested variable from the application pack corresponding to process ID. The retrieved value from the private application pack is returned (in step 516) to the requesting process. For a write operation originated from secured application, it is serviced under the private environment. When a write operation for environmental variable occurs, the private subsystem checks (in step 510) the presence of variable in the private system environment. If the variable does not exist in the private environmental system then the variable is created (in step 512) and the value is stored within the private environmental system. In case if the variable exist in the private environmental system then the value is updated (in step 514) for the requested variable and returns the status of operation to the requesting process.

System environment information are defined and configured during the installation process. The system administrator can modify the environment information. Operating system 100 refers to the system environment variables for its system path and all its environmental resources. In case, if use of same variables to set different value, the system over rides the existing value with the current value. This will cause system variable conflicts. In the preferred embodiment, Application wrapper 120 sets the system environment variables for application software within the Application wrapper 120 without affecting the existing system environmental information. Original system environmental variables are kept unaffected.

User environment information requires to an application are defined by the application software at the time of application installation. The environmental values differ for each user of a user computer. The user environment variables include any user-defined settings such as a desktop pattern and any variables defined by applications such as the path to the location of the application files 132. Users can manage their user environment values to user environmental variables. In case, if an application installation uses an existing environment variable to set a different value for that particular application, it will over ride the prior setting with a new value. This will cause conflicts between application environment values used for these applications. In the preferred embodiment, Application wrapper 120 sets user environment variables to application software within the Application wrapper 120 without affecting the existing user environmental information. Other user environmental variables used in other application are kept unaffected.

Application Configuration

In most of the aspects, application software will have the run-time settings in an application configuration file 140 shown in FIG. 2. FIG. 2, shows the application configuration settings for application software. Application software refers to the configuration settings during the loading of application software or while it is executing. In most of the aspects these settings on configuration files are affected by other application installation, which uses the same type of parameter or settings in the configuration file. Also it may over rides the entire configuration file and corrupts the previously installed settings.

In the preferred embodiment, the Application wrapper 120 provides the configuration files separately within the secured run-time environment 130. Providing this function, applications may use the same parameter or settings in the configuration file but does not conflict each other by retaining the each application configuration file independently. Whatever configuration file required for the process is kept separately under the secured application pack. Hence configuration files can be retrieved through private file system and privates the application configuration.

Application Launcher

In the present invention, an application launcher shown in FIG. 5 refers the initiation of secured application. Whenever a secured application in step 152 is requested to execute, the application launcher will check the presence of required Application wrapper system resources in step 154 to perform the execution. The application launcher will receive the request to execute the said secured application. Launcher will verify and establishes whether all the application system resources are initiated. In case if the system is already initiated then the system initialization process will be skipped and directly it will perform application process initiation in step 162. In case if the system is not initiated the launcher will initiate all the application wrapper modules in steps 156-160. The system initialization process includes privatized virtual file system driver and privatized virtual registry system driver. In step 156, the privatized virtual file system driver is loaded dynamically above the operating system file system as like virtual file system. Similarly, the privatized virtual registry system driver is loaded dynamically above the operating system registry system as like virtual registry system. These drivers can be loaded and unloaded dynamically based on the application process status. Further at step 158, it initializes private component system, component redirection table, private environment system and private configuration system. Finally at step 160, cache manager and process manager is executed and initiated.

When the system initialization process is completed, the application wrapper system will be at ready state to execute the secured application. During the initiation of secured application, the launcher downloads initializing data for the requested secured application using an ftp module via cache manager from a remote server in step 162. Further in step 164, the launcher mounts the downloaded data for mounting privatized virtual file system 142 and privatized virtual registry system. Using the mounted privatized virtual file system; the said application launcher can view the files and directories required for the secured application. In step 165, the said application launcher registers privatized virtual components required for the secured application to use in service control manager for IPC and the component redirecting information for each component required by the said selected secured application is added to the component redirection table. Finally in step 166, the main executable file name is located and triggered to execute.

Process Manager

In the present invention, one preferred embodiment is the process manager 148, which maintains the application runtime status in a process list. Application software resources brought to secure run-time environment are invisible to other executions. In FIG. 2, refers to process manager 148 that executes each application with their own resources from their own run-time environment. In some cases, application software may require to use other application software resources to chain the execution for several uses. Example: Microsoft office comes with several packages like word, excel, power point, access etc., Process manager 148 executes the necessary shared application software resources for interlinked application software. Hence the process id and child process id is stored in a process list to maintain the interconnected processes.

FIG. 5 illustrates a process manager method in accordance with the invention. Whenever a process is initiated in the operating system, a process ID is created. The process manager monitors the process continuously and retrieves process ID from operating system process list (in step 174). Once the process ID is retrieved, it is verified to establish the process as operating system 100 process or secured application process in step 176. If the process ID belongs to secured application then it checks the process list for the presence of secured application process ID in step 178. Further, if the process ID is found to be new then the process ID and relevant information to that process is added (in step 180) in the process. Similarly, all the process ID in the process list is verified in the operating system process list in step 182. If any process ID not found in operating system process list, that process ID is deleted (in step 184) from the process list. Finally, it checks for empty process list in step 186. If there is no process ID in the process list, it is understood that there is no secured application running on the operating system. Once the process list is determined to be empty, the process manager cleans up (in step 188) the entire systems by unloading all the initialized routines.

Cache Manager

In one embodiment of the present invention, includes a cache manager 150, which facilitates the secured run-time environment 130 to keep the simulated data saved for further use of these data to execute the application from the cache. FIG. 2, shows the cache manager 150 for caching application resources retrieved in the process. Whenever an application requires a different portion of application data, an application data simulated process determines the requested portion of application data and downloads the requested application data. Further, the downloaded data is return to the run-time environment to incrementally execute the application. In between this process, a cache facility is introduced to reduce the application data retrieval time. The retrieved application data is stored in a cache database within the application wrapper 120. Having cache facility, the application data simulated process checks the cache for the availability of requested application data. If the application data is available in the cache database then the application data is retrieved from the cache and returns to the secured run-time environment 130 otherwise, it retrieves from the original available sources. This reduces the simulation time and speeds up the execution of application software. The application data is encrypted and cannot be used by any other application or users.

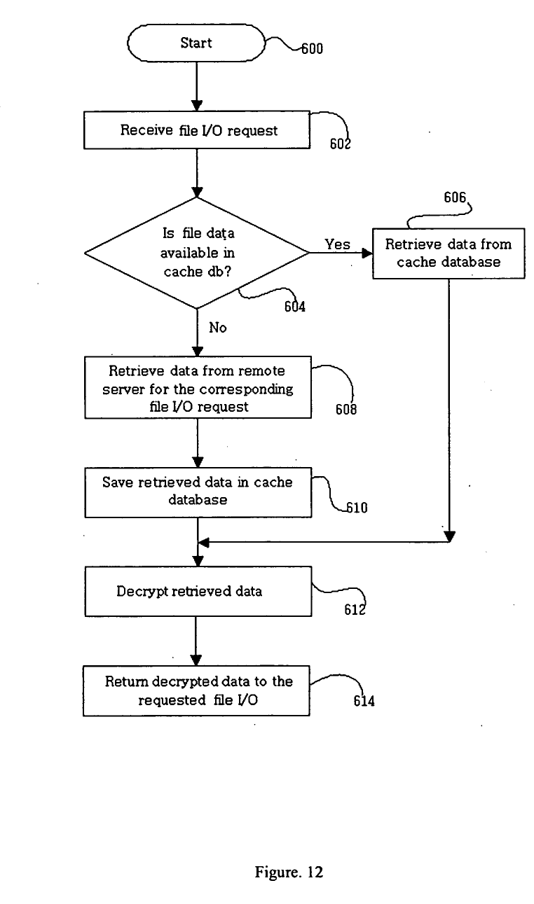

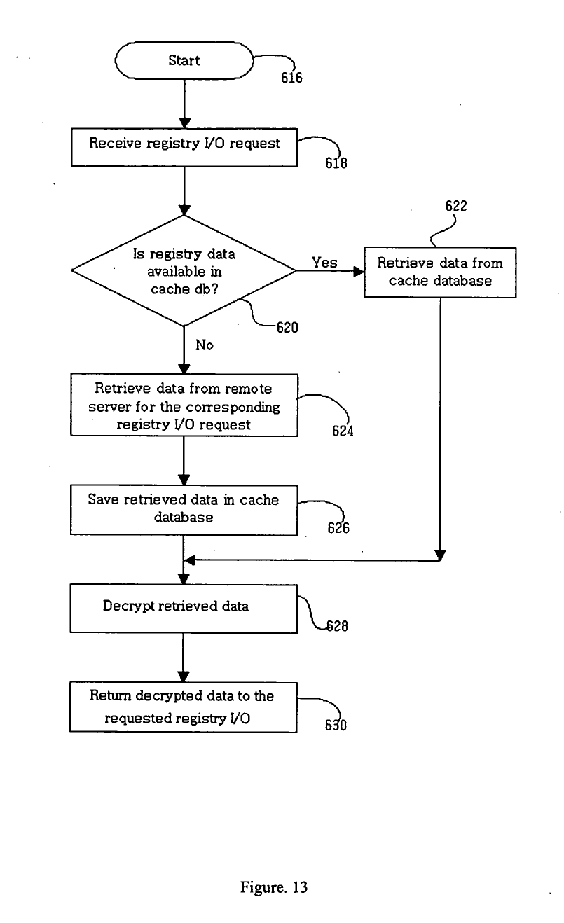

In the present invention, the method of caching file data is shown in FIG. 12 and caching registry data is shown in FIG. 13. As shown in FIG. 12, when a file I/O request is sent to cache manager in step 602, the cache manger responds the requesting module with the necessary data. The data required for the I/O request is searched from a cache database available for the corresponding process in step 604. If the required data is not found in cache database then the data is retrieved (in step 608) from a remote network and saves (in step 610) the data in cache database. Finally, if the file data is available in the cache database, the required data is retrieved (in step 606) from the cache database, which is in a form of encrypted data. The encrypted data is decrypted (in step 612) and returned (in step 614) to the requesting file I/O request.

Similarly, in the present invention, the method of caching registry data is shown in FIG. 13. For some application the size of the registry might be huge. It takes huge time to retrieve all the registry entries from a remote system to serve the secured application in a better speed. Whatever registry keys required for executing the secured application is brought to the process on demand. In FIG. 13, the function of cache manager for private registry system 144 is explained. When a registry I/O request is sent to cache manager in step 618, the cache manger responds the requesting module with the necessary registry information. The registry information required for the I/O request is searched from a cache database available for the corresponding process in step 620. If the required registry information is not found in cache database then the registry information is retrieved (in step 624) from a remote network and saves the registry data in cache database in step 626. Finally, if the registry data is not in the cache database, the required data is retrieved (in step 622) from the cache database, which is in a form of encrypted data. The encrypted data is then decrypted (in step 628) and returned (in step 630) to the requesting file I/O request.

While the foregoing has been with reference to a particular embodiment of the invention, it will be appreciated by those skilled in the art that changes in this embodiment may be made without departing from the principles and spirit of the invention, the scope of which is defined by the appended claims.

1. A system for executing application software on a operating system within a secured run-time environment without affecting an application software resources of a client computer, the system comprising:
an application wrapper, wherein said application wrapper shields the application software resources, whereby said secured run-time environment for executing said application software is created and the application software resources are protected; and
the application wrapper further comprising a privatized virtual file resource created from an operating system file system, a privatized virtual registry created from an operating system registry system, a privatized operating system shared component resource, a privatized application configuration resource and a privatized environmental resources for application variables.

2. The system of claim 1, wherein privatized virtual file resource further comprising:
intercepting file I/O request generated by one or more processes;
establishing a process ID for the intercepted file I/O request;
comparing process ID to establish operating system process and secured run-time process;
establishing a process ID as operating system process and secured run-time process;
servicing the file I/O request for all process ID established as secured run-time process;
redirecting the file I/O request to operating system service for process ID established as operating system process;
rejecting the file I/O request on secured run-time process resources for process ID established as operating system process;
comparing process ID established as secured run-time process to further establish process resources corresponding to process ID;
establishing corresponding process resources within secured run-time resources; and
rejecting the file I/O request on secured run-time process resources for process ID established as secured run-time process and process ID belongs to other process resources.

3. The system of claim 1, wherein privatized virtual registry further comprises:
privatizing virtual registry system by intercepting registry I/O request generated by several process;
establishing process ID for the intercepted registry I/O request;
comparing process ID to establish operating system process and secured run-time process;
establishing process ID as operating system process and secured run-time process;
servicing the registry I/O request for all process ID established as secured run-time process;
redirecting the registry I/O request to operating system service for process ID established as operating system process;
rejecting the registry I/O request on secured run-time process resources for process ID established as operating system process;
comparing process ID established as secured run-time process to further establish process resources corresponding to process ID;
establishing corresponding process resources within secured run-time resources; and
rejecting the registry I/O request on secured run-time process resources for process ID established as secured run-time process and process ID belongs to other process resources.

4. The system of claim 1, wherein privatizing operating system shared component resource further comprising:
searching secured application process for injecting component hooker;
checking the said secured application process to establish whether the process is injected with component hooker;
establishing the said secured application process as new secured application process for said secured application process not injected with component hooker;
injecting component hooker to new secured application process to intercept component process;
repeating component hooker injection for all the new secured application process;

5. The system of claim 1, wherein privatizing operating system shared component resource further comprising:
Initializing component redirection table to provide component redirecting information;
Registering virtual component required for the secured application;
Adding redirecting information to the said component redirection table for the execution of each selected said secured run-time application;
Removing component redirecting information from the said component redirection table for the termination of each said secured run-time application;

6. The system of claim 1, wherein privatizing operating system shared component resource further comprising:
intercepting component process function for replacing component search path with secured application resource path;
replacing component search path with private resource path to load the component from the secured application resource path; and
creating new process for the intercepted component with the replaced secured application resource path.

7. The system of claim 1, wherein privatizing operating system shared component resource further comprising:
intercepting component call for replacing component registry path with the said privatized virtual registry path;
searching component redirection table for the said component redirecting information;
replacing component registry path with the said privatized virtual registry path retrieved from the said component redirection table;
returning the intercepted call to the requested call with the replaced secured application registry path for addressing the component location from the privatized virtual registry system and further the said component is addressed to load from the said privatized virtual file system;
redirecting the said component call as it is to the requested call for the said component call originated from non secured run-time application and for the said component call, which do not have redirecting information in the said component redirection table.

8. The system of claim 1, wherein privatizing operating system shared component resource further comprising:
intercepting the said RPC message call for replacing component information with privatized virtual component information;
searching component redirecting information from the said component redirection table;
replacing RPC message with the said privatized virtual component information retrieved from the said component redirection table;
returning the intercepted RPC message call to the requested call with the replaced message;
continuing the RPC call to locate the privatized virtual component through SCM;
redirecting the said RPC message call as it is to the requested call for the said component call originated from non secured run-time application and for the said component call, which do not have redirecting information in the said component redirection table.

9. The system of claim 1, wherein privatized application configuration resource further comprises:
monitoring file I/O request for configuration file to provide separate configuration file;
searching and retrieving configuration file from secured application resources; and
serving application configuration file to requesting process.

10. The system of claim 1, wherein privatized environmental resources further comprises:
intercepting environment variable request to supply private values to secured application process;
verifying process ID to establish the process ID as operating system process or secured application process;
redirecting the call for process ID established as operating system process;
reading variable data from secured application resource and returning the value to requested process for read variable calls requested by the secured application process;
searching the requesting write variable in secured application resource to find the presence of requesting write variable;
creating variable with variable data within secured application resource and returning the status to requested process for variable do not exist in secured application resource; and
updating variable with variable data within secured application resource and returning the status to requested process for variable exist in secured application resource.

11. The system of claim 1, wherein the application wrapper further comprises selectively allowing the application software to interact operating system resources directly during the said application software executing under the said secured run-time environment.

12. The system of claim 1, wherein the application wrapper further comprises selectively allowing said application software to interact with other application software resources directly during the said application software executing under the said secured run-time environment.

13. The system of claim 1, wherein said application wrapper further comprises providing a run-time environment to said application software that is visible to an operating system run-time environment without having said application software run-time resources, whereby said application software resources is simulated to said secured run-time environment during the execution of said application software.

14. The system of claim 13, further comprising means for protecting the behavior of said application software from other application and said operating system.

15. The system of claim 13, further comprising means for eliminating said application conflicts from other running application software.

16. The system of claim 13, further comprising means for executing multiple instance of single said application software.

17. The system of claim 1, wherein the said application wrapper further comprising maintaining the application software resources away from said operating system resources, whereby said operating system resources is protected from said application software resources.

18. The system of claim 1, wherein said application wrapper further comprises permitting full access to said application software that requires to access for variation occurs to said application software resources within the said application wrapper.

19. The system of claim 18 further comprising means for keeping the state of secured run-time environment to said application software.

20. The system of claim 18, further comprising means for updating said application software resources required by said application software.

21. The system of claim 1, wherein the said application wrapper monitors the said application run-time request to determine the required said application software resources for execution.

22. The system of claim 21, further comprising means for receiving said application software resources to execute said application software in the said secured run-time environment.

23. The system of claim 21, further comprising means for incrementally executing the said application software in the secured run-time environment.

24. A method for executing application software on a operating system within a secured run-time environment without affecting an application software resources of a client computer, the client compute comprising an application wrapper, wherein said application wrapper shields the said application software resources, whereby a said secured run-time environment for executing an said application software is created and the said application software resources is protected, the method further comprising:
privatizing virtual file resource created from an operating system file system;
privatizing virtual registry created from an operating system registry system;
privatizing operating system shared component resource;
privatizing application configuration resource; and
privatizing environmental resources for application variables.

25. The method of claim 24, wherein privatizing the virtual file resource further comprising:
intercepting file I/O request generated by several processes;
establishing process ID for the intercepted file I/O request;
comparing process ID to establish operating system process and secured run-time process;
establishing process ID as operating system process and secured run-time process;
servicing the file I/O request for all process ID established as secured run-time process;
redirecting the file I/O request to operating system service for process ID established as operating system process;
rejecting the file I/O request on secured run-time process resources for process ID established as operating system process;
comparing process ID established as secured run-time process to further establish process resources corresponding to process ID;
establishing corresponding process resources within secured run-time resources; and
rejecting the file I/O request on secured run-time process resources for process ID established as secured run-time process and process ID belongs to other process resources.

26. The method of claim 24, wherein Privatizing the virtual registry further comprising:
privatizing virtual registry system by intercepting registry I/O request generated by several process;
establishing process ID for the intercepted registry I/O request;
comparing process ID to establish operating system process and secured run-time process;
establishing process ID as operating system process and secured run-time process;
servicing the registry I/O request for all process ID established as secured run-time process;
redirecting the registry I/O request to operating system service for process ID established as operating system process;
rejecting the registry I/O request on secured run-time process resources for process ID established as operating system process;
comparing process ID established as secured run-time process to further establish process resources corresponding to process ID;
establishing corresponding process resources within secured run-time resources; and
rejecting the registry I/O request on secured run-time process resources for process ID established as secured run-time process and process ID belongs to other process resources.

27. The method of claim 24, wherein privatizing operating system shared component resource further comprising:
intercepting component process function for replacing component search path with secured application resource path;
replacing component search path with private resource path to load the component from the secured application resource path; and
creating new process for the intercepted component with the replaced secured application resource path.

28. The method of claim 24, wherein privatizing operating system shared component resource further comprising:
searching secured application process for injecting component hooker;
checking the said secured application process to establish whether the process is injected with component hooker;
establishing the said secured application process as new secured application process for said secured application process not injected with component hooker;
injecting component hooker to new secured application process to intercept component process;
repeating component hooker injection for all the new secured application process;

29. The method of claim 24, wherein privatizing operating system shared component resource further comprising:
Initializing component redirection table to provide component redirecting information;
Registering virtual component required for the secured application;
Adding redirecting information to the said component redirection table for the execution of each selected said secured run-time application;
Removing component redirecting information from the said component redirection table for the termination of each said secured run-time application;

30. The method of claim 24, wherein privatizing operating system shared component resource further comprising:
intercepting component call for replacing component registry path with the said privatized virtual registry path;
searching component redirection table for the said component redirecting information;
replacing component registry path with the said privatized virtual registry path retrieved from the said component redirection table;
returning the intercepted call to the requested call with the replaced secured application registry path for addressing the component location from the privatized virtual registry system and further the said component is addressed to load from the said privatized virtual file system;
redirecting the said component call as it is to the requested call for the said component call originated from non secured run-time application and for the said component call, which do not have redirecting information in the said component redirection table.

31. The method of claim 24, wherein privatizing operating system shared component resource further comprising:
intercepting the said RPC message call for replacing component information with privatized virtual component information;
searching component redirecting information from the said component redirection table;
replacing RPC message with the said privatized virtual component information retrieved from the said component redirection table;
returning the intercepted RPC message call to the requested call with the replaced message;
continuing the RPC call to locate the privatized virtual component through SCM;
redirecting the said RPC message call as it is to the requested call for the said component call originated from non secured run-time application and for the said component call, which do not have redirecting information in the said component redirection table.

32. The method of claim 24, wherein privatizing application configuration resource further comprising:
monitoring file I/O request for configuration file to provide separate configuration file;
searching and retrieving configuration file from secured application resources; and
serving application configuration file to requesting process.

33. The method of claim 24, wherein privatizing environmental resources for application variables further comprising:
intercepting environment variable request to supply private values to secured application process;
verifying process ID to establish the process ID as operating system process or secured application process;
redirecting the call for process ID established as operating system process;
reading variable data from secured application resource and returning the value to requested process for read variable calls requested by the secured application process;
searching the requesting write variable in secured application resource to find the presence of requesting write variable;
creating variable with variable data within secured application resource and returning the status to requested process for variable do not exist in secured application resource; and
updating variable with variable data within secured application resource and returning the status to requested process for variable exist in secured application resource.

34. The method of claim 24, wherein selectively allows said application software to interact operating system resources directly during the said application software executing under the said secured run-time environment.

35. The method of claim 24, wherein selectively allows said application software to interact with other application software resources directly during the said application software executing under the said secured run-time environment.

36. The method of claim 24, wherein said application wrapper provides an run-time environment to said application software that visible to be an operating system run-time environment without having said application software run-time resources, whereby said application software resources is simulated to said secured run-time environment during the execution of said application software.

37. The method of claim 36, further comprising protecting the behavior of said application software from other application and said operating system.

38. The method of claim 36, further comprising eliminating said application conflicts from other running application software.

39. The method of claim 36, further comprising executing multiple instance of single said application software.

40. The method of claim 24, wherein the said application wrapper keeps the application software resources away from said operating system resources, whereby said operating system resources is protected from said application software resources.

41. The method of claim 24, wherein said application wrapper allows full access to said application software that requires to access for variation occurs to said application software resources within the said application wrapper.

42. The method of claim 41, further comprising a means for keeping the state of secured run-time environment to said application software.

43. The method of claim 41, further comprising a means for updating said application software resources required by said application software.

44. The method of claim 24, wherein the said application wrapper monitors the said application run-time request to determine the required said application software resources for execution.

45. The method of claim 44, further comprising a means for receiving said application software resources to execute said application software in the said secured run-time environment.

46. The method of claim 44, further comprising a means for incrementally executing the said application software in the secured run-time environment.
